(19) United States
(12) Patent Application Publication
(10) Pub. No.: US 2011/0069086 A1
(43) Pub. Date: Mar. 24, 2011

(54) Detail-in-Context Presentations in Client/Server Systems

(76) Inventors: Garth B. D. Shoemaker, Vancouver (CA); Mark H. A Tigges, Vancouver (CA); David J. P. Baar, Vancouver (CA); Michael Doyle, Vancouver (CA); Zeenat Jetha, N. Vancouver (CA); Stacy Gorkoff, Vancouver (CA)

(21) Appl. No.: 12/489,368

(22) Filed: Jun. 22, 2009

Related U.S. Application Data
(63) Continuation-in-part of application No. 12/388,437, filed on Feb. 18, 2009.
Application No. 12/388,437 is a continuation of application No. 10/989,070, filed on Nov. 16, 2004, now Pat. No. 7,495,678.
Application No. 10/989,070 is a continuation-in-part of application No. 11/542,120, filed on Oct. 4, 2006, now abandoned.
Application No. 11/542,120 is a continuation-in-part of application No. 10/682,298, filed on Oct. 10, 2003.
(60) Provisional application No. 60/727,507, filed on Oct. 18, 2005.

(30) Foreign Application Priority Data
Oct. 10, 2002 (CA) 2,407,383
Nov. 17, 2003 (CA) 2,449,888

(51) Int. Cl. G09G 5/00

(52) U.S. Cl. 345/641; 345/671

(57) ABSTRACT

A method for generating a presentation of a region-of-interest in an original image for display on a display screen of a client coupled over a network to a server, comprising: establishing a lens having a focal region for the region-of-interest at least partially surrounded by a shoulder region; if the lens is in transit between first and second locations for the region-of-interest in the original image, applying the lens to the original image by a first method to generate the presentation at the client; and, if the lens is stationary in the original image, receiving the presentation from the server, the server applying the lens to the original image by a second method to generate the presentation.

### RELATED APPLICATIONS

The application claims priority under 35 U.S.C. §120 as a continuation-in-part of U.S. patent application Ser. No. 12/388, 437, filed Feb. 18, 2009 which is a continuation of U.S. application Ser. No. 10/989,070 (U.S. Pat. No. 7,495,678), filed Nov. 16, 2004, which claims priority to Canadian Application No. 2,449,888, filed Nov. 17, 2003; U.S. patent application Ser. No. 11/542,120, filed Oct. 4, 2006 which claims priority to U.S. Provisional Application No. 60/727,507, filed Oct. 18, 2005; and U.S. patent application Ser. No. 10/682,298, filed Oct. 10, 2003 which claims priority to Canadian Application 2,407,383, filed Oct. 10, 2002, the entire disclosures of each of the above listed applications are hereby incorporated by reference.

### BACKGROUND

Modern computer graphics systems, including virtual environment systems, are used for numerous applications such as mapping, navigation, flight training, surveillance, and even playing computer games. In general, these applications are launched by the computer graphics system's operating system upon selection by a user from a menu or other graphical user interface (“GUI”). A GUI is used to convey information to and receive commands from users and generally includes a variety of GUI objects or controls, including icons, toolbars, drop-down menus, text, dialog boxes, buttons, and the like. A user typically interacts with a GUI by using a pointing device (e.g., a mouse) to position a pointer or cursor over an object and “clicking” on the object.

One problem with these computer graphics systems is their inability to effectively display detailed information for selected graphic objects when those objects are in the context of a larger image. A user may require access to detailed information with respect to an object in order to closely examine the object, to interact with the object, or to interface with an external application or network through the object. For example, the detailed information may be a close-up view of the object or a region of a digital map image.

While an application may provide a GUI for a user to access and view detailed information for a selected object in a larger image, in doing so, the relative location of the object in the larger image may be lost to the user. Thus, while the user may have gained access to the detailed information required to interact with the object, the user may lose sight of the context within which that object is positioned in the larger image. This is especially so when the user must interact with the GUI using a computer mouse or keyboard. The interaction may further distract the user from the context in which the detailed information is to be understood. This problem is an example of what is often referred to as the “screen real estate problem”.

### SUMMARY

According to one aspect, there is provided a method for generating a presentation of a region-of-interest in an original image for display on a display screen of a client coupled over a network to a server, comprising: establishing a lens having a focal region for the region-of-interest at least partially surrounded by a shoulder region; if the lens is in transit between first and second locations for the region-of-interest in the original image, applying the lens to the original image by a first method to generate the presentation at the client; and, if the lens is stationary in the original image, receiving the presentation from the server, the server applying the lens to the original image by a second method to generate the presentation.

In the above method, the first method may require less resources than the second method. The lens may have a shape and the second method may more accurately reflect the shape of the lens in the presentation than the first method. The shoulder region may have a shape and the second method may more accurately reflect the shape of the shoulder region in the presentation than the first method. The second method may include displacing the original image onto the lens to produce a displaced image and projecting the displaced image onto a plane in a direction aligned with a viewpoint for the region-of-interest. The first method may include: creating a focal region image for the focal region by scaling the original image within the focal region by a focal region magnification; creating a shoulder region image for the shoulder region by scaling the original image within the shoulder region by a shoulder region magnification, the shoulder region magnification being less than the focal region magnification; and, overlaying the focal region image and the shoulder region image on the original image. The method may further include receiving a signal indicating the transit between the first and second locations from a graphical user interface (“GUI”) displayed over the lens on the display screen. The method may further include, if the lens is stationary in the original image, sending a signal from the client to the server requesting the presentation. The method may further include, if the lens is stationary in the original image and if the server is unavailable, applying the lens to the original image by the first method to generate the presentation at the client. And, the method may further include displaying the presentation on the display screen.

In accordance with further aspects there is provided an apparatus such as a data processing system, a method for adapting this system, as well as articles of manufacture such as a computer readable storage medium having program instructions recorded thereon for practicing the method.

### BRIEF DESCRIPTION OF THE DRAWINGS

Further features and advantages of the embodiments will become apparent from the following detailed description, taken in combination with the appended drawings, in which:

FIG. 1 is a graphical representation illustrating the geometry for constructing a three-dimensional perspective viewing frustum, relative to an x, y, z coordinate system, in accordance with elastic presentation space graphics technology;

FIG. 2 is a graphical representation illustrating the geometry of a presentation in accordance with elastic presentation space graphics technology;

FIG. 3 is a block diagram illustrating a data processing system adapted for implementing an embodiment;

FIG. 4 is a partial screen capture illustrating a GUI having lens control elements for user interaction with detail-in-context data presentations in accordance with an embodiment;

FIG. 5 is a screen capture illustrating a presentation having a rectangular inset lens in accordance with an embodiment;

FIG. 6 is a top view illustrating the structure of a pyramid lens in accordance with an embodiment;

FIG. 7 is a side view illustrating the pyramid lens of FIG. 6 in accordance with an embodiment; and,

FIG. 8 is a flow chart illustrating operations of modules within the memory of a data processing system for generating a presentation of a region-of-interest in an original image for display on a display screen, the data processing system coupled over a network to a server, in accordance with an embodiment.

It should be noted that throughout the appended drawings, like features are identified by like reference numerals.

### DETAILED DESCRIPTION

In the following description, the term “data processing system” is used herein to refer to any machine for processing data, including the computer systems and network arrangements described herein. The techniques described herein may be implemented in any computer programming language, e.g., an operating system. The techniques may also be implemented in hardware.

The “screen real estate problem” generally arises whenever large amounts of information are to be displayed on a display screen of limited size. Known tools to address this problem include panning and zooming. While these tools are suitable for a large number of visual display applications, they become less effective where sections of the visual information are spatially related, such as in layered maps and three-dimensional representations, for example. In this type of information display, panning and zooming are not as effective as much of the context of the panned or zoomed display may be hidden.

A recent solution to this problem is the application of “detail-in-context” presentation techniques. Detail-in-context is the magnification of a particular region-of-interest (the “focal region” or “detail”) in a data presentation while preserving visibility of the surrounding information (the “context”). This technique has applicability to the display of large surface area media (e.g. digital maps) on computer screens of variable size including graphics workstations, laptop computers, personal digital assistants (“PDAs”), and cell phones.

In the detail-in-context discourse, differentiation is often made between the terms “representation” and “presentation”. A representation is a formal system, or mapping, for specifying raw information or data that is stored in a computer or data processing system. For example, a digital map of a city is a representation of raw data including street names and the relative geographic location of streets and utilities. Such a representation may be displayed visually on a computer screen or printed on paper. On the other hand, a presentation is a spatial organization of a given representation that is appropriate for the task at hand. Thus, a presentation of a representation organizes such things as the point of view and the relative emphasis of different parts or regions of the representation. For example, a digital map of a city may be presented with a region magnified to reveal street names.

In general, a detail-in-context presentation may be considered as a distorted view (or distortion) of a portion of the original representation or image where the distortion is the result of the application of a “lens” like distortion function to the original representation. A detailed review of various detail-in-context presentation techniques such as “Elastic Presentation Space” (“EPS”) (or “Pliable Display Technology” (“PDT”)) may be found in a publication by Marianne S. T. Carpendale, entitled “A Framework for Elastic Presentation Space” (Carpendale, Marianne S. T., A Framework for Elastic Presentation Space (Burnaby, British Columbia: Simon Fraser University, 1999)), and incorporated herein by reference.

In general, detail-in-context data presentations are characterized by magnification of areas of an image where detail is desired, in combination with compression of a restricted range of areas of the remaining information (i.e. the context), the result typically giving the appearance of a lens having been applied to the display surface. Using the techniques described by Carpendale, points in a representation are displaced in three dimensions and a perspective projection is used to display the points on a two-dimensional presentation display. Thus, when a lens is applied to a two-dimensional continuous surface representation, for example, the resulting presentation appears to be three-dimensional. In other words, the lens transformation appears to have stretched the continuous surface in a third dimension. In EPS graphics technology, a two-dimensional visual representation is placed onto a surface; this surface is placed in three-dimensional space; the surface, containing the representation, is viewed through perspective projection; and the surface is manipulated to effect the reorganization of image details. The presentation transformation is separated into two steps: surface manipulation or distortion and perspective projection.

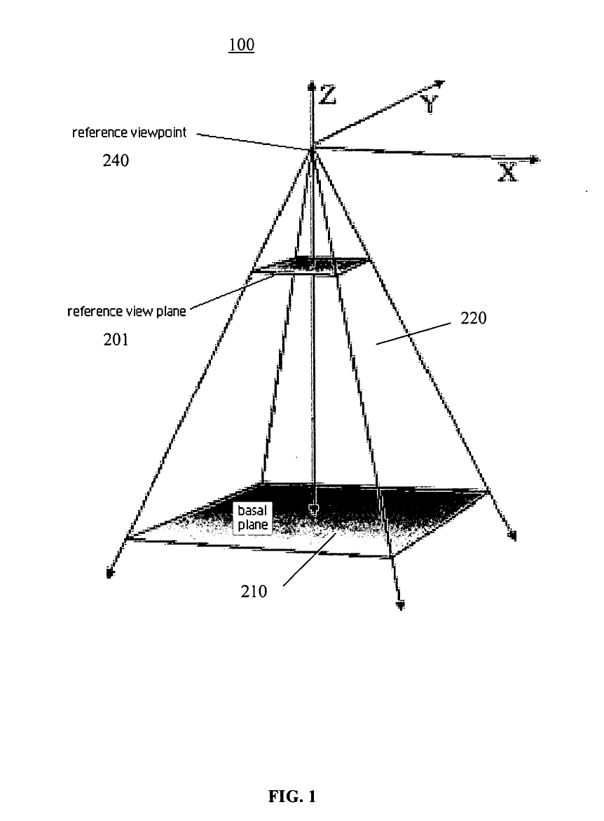

FIG. 1 is a graphical representation illustrating the geometry 100 for constructing a three-dimensional (“3D”) perspective viewing frustum 220, relative to an x, y, z coordinate system, in accordance with elastic presentation space (EPS) graphics technology. In EPS technology, detail-in-context views of two-dimensional (“2D”) visual representations are created with sight-line aligned distortions of a 2D information presentation surface within a 3D perspective viewing frustum 220. In EPS, magnification of regions-of-interest and the accompanying compression of the contextual region to accommodate this change in scale are produced by the movement of regions of the surface towards the viewpoint (“VP”) 240 located at the apex of the pyramidal shape 220 containing the frustum. The process of projecting these transformed layouts via a perspective projection results in a new 2D layout which includes the zoomed and compressed regions. The use of the third dimension and perspective distortion to provide magnification in EPS provides a meaningful metaphor for the process of distorting the information presentation surface. The 3D manipulation of the information presentation surface in such a system is an intermediate step in the process of creating a new 2D layout of the information.

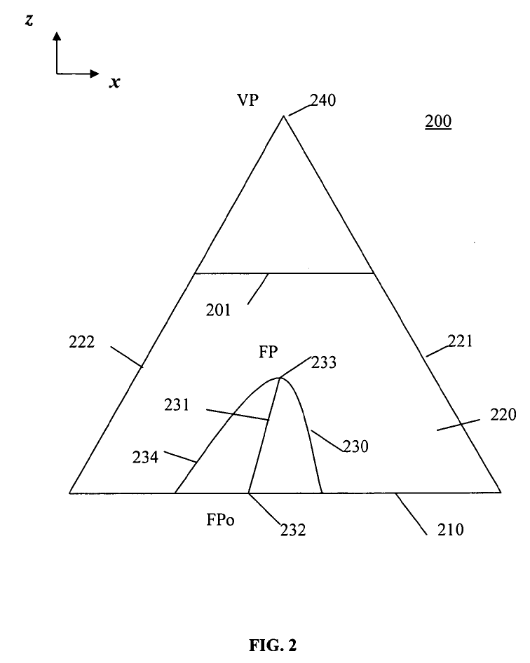

FIG. 2 is a graphical representation illustrating the geometry 200 of a presentation in accordance with EPS graphics technology. EPS graphics technology employs viewer-aligned perspective projections to produce detail-in-context presentations in a reference view plane 201 which may be viewed on a display. Undistorted 2D data points are located in a base plane 210 of a 3D perspective viewing volume or frustum 220 which is defined by extreme rays 221 and 222 and the base plane 210. The VP 240 is generally located above the centre point of the base plane 210 and reference view plane (“RVP”) 201. Points in the base plane 210 are displaced upward onto a distorted surface or “lens” 230 which is defined by a general 3D distortion function (i.e., a detail-in-context distortion basis function). The direction of the perspective projection corresponding to the distorted surface 230 is indicated by the line FPo-FP 231 drawn from a point FPo 232 in the base plane 210 through the point FP 233 which corresponds to the focal point, focus, or focal region 233 of the distorted surface 230. Typically, the perspective projection has a direction 231 that is viewer-aligned (i.e., the points FPo 232, FP 233, and VP 240 are collinear).

EPS is applicable to multidimensional data and is well suited to implementation on a computer for dynamic detail-in-context display on an electronic display surface such as a monitor. In the case of two dimensional data, EPS is typically characterized by magnification of areas of an image where detail is desired 233, in combination with compression of a restricted range of areas of the remaining information (i.e., the context) 234, the end result typically giving the appearance of a lens 230 having been applied to the display surface. The areas of the lens 230 where compression occurs may be referred to as the “shoulder” 234 of the lens 230. The area of the representation transformed by the lens may be referred to as the “lensed area”. The lensed area thus includes the focal region 233 and the shoulder region 234. Typically, the distorted surface, distortion function, or lens 230 provides a continuous or smooth transition from the base plane 210 through the shoulder region 234 to the focal region 233 as shown in FIG. 2. However, of course, the distorted surface, distortion function, or lens 230 may have a number of different shapes (e.g., truncated pyramid, etc.). To reiterate, the source image or representation to be viewed is located in the base plane 210. Magnification 233 and compression 234 are achieved through elevating elements of the source image relative to the base plane 210, and then projecting the resultant distorted surface onto the reference view plane 201. EPS performs detail-in-context presentation of n-dimensional data through the use of a procedure wherein the data is mapped into a region in an (n+1) dimensional space, manipulated through perspective projections in the (n+1) dimensional space, and then finally transformed back into n-dimensional space for presentation. EPS has numerous advantages over conventional zoom, pan, and scroll technologies, including the capability of preserving the visibility of information outside 210, 234 the local region of interest 233.

For example, and referring to FIGS. 1 and 2, in two dimensions, EPS can be implemented through the projection of an image onto a reference plane 201 in the following manner. The source image or representation is located on a base plane 210, and those regions of interest 233 of the image for which magnification is desired are elevated so as to move them closer to a reference plane situated between the reference viewpoint 240 and the reference view plane 201. Magnification of the focal region 233 closest to the RVP 201 varies inversely with distance from the RVP 201. As shown in FIGS. 1 and 2, compression of regions 234 outside the focal region 233 is a function of both distance from the RVP 201, and the gradient of the function (i.e., the shoulder function or drop-off function) describing the vertical distance from the RVP 201 with respect to the horizontal distance from the focal region 233. The resultant combination of magnification 233 and compression 234 of the image as seen from the reference viewpoint 240 results in a lens-like effect similar to that of a magnifying glass applied to the image. Hence, the various functions used to vary the magnification and compression of the source image via vertical displacement from the basal plane 210 are described as lenses, lens types, or lens functions. Lens functions that describe basic lens types with point and circular focal regions, as well as certain more complex lenses and advanced capabilities such as folding, have previously been described by Carpendale.

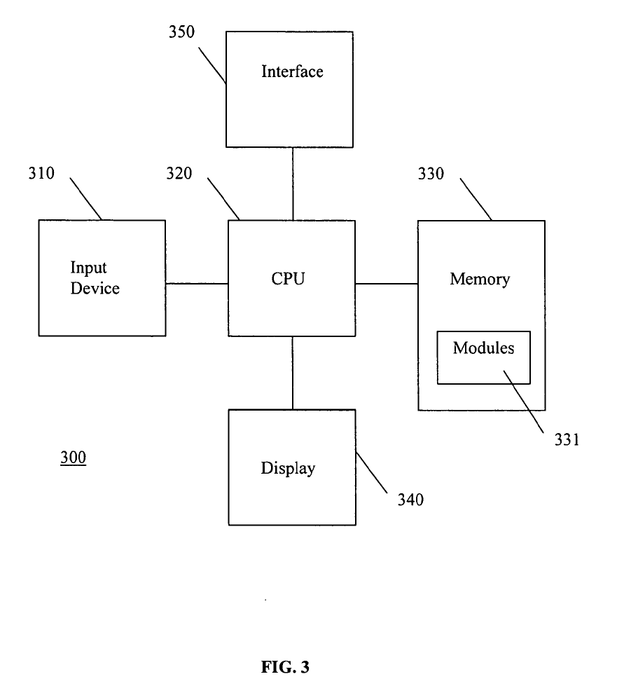

FIG. 3 is a block diagram of a data processing system 300 adapted to implement an embodiment. The data processing system 300 is suitable for generating, displaying, and adjusting detail-in-context lens presentations in conjunction with a detail-in-context graphical user interface (“GUI”) 400, as described below. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The CPU 320 may include dedicated coprocessors and memory devices. The memory 330 may include RAM, ROM, databases, or disk devices. The display 340 may include a computer screen, terminal device, a touch sensitive display surface or screen, or a hardcopy producing output device such as a printer or plotter. And, the interface device 350 may include an interface to a network (not shown) such as the Internet and/or another wired or wireless network. Thus, the data processing system 300 may be linked to other data processing systems (not shown) by a network (not shown). For example, the data processing system 300 may be a client and/or server in a client/server system. The data processing system 300 has stored therein data representing sequences of instructions which when executed cause the method described herein to be performed. Of course, the data processing system 300 may contain additional software and hardware.

Thus, the data processing system 300 includes computer executable programmed instructions for directing the system 300 to implement the embodiments described herein. The programmed instructions may be embodied in one or more hardware or software modules 331 resident in the memory 330 of the data processing system 300. Alternatively, the programmed instructions may be embodied on a computer readable medium (such as a CD disk or floppy disk) which may be used for transporting the programmed instructions to the memory 330 of the data processing system 300. Alternatively, the programmed instructions may be embedded in a computer-readable signal or signal-bearing medium that is uploaded to a network by a vendor or supplier of the programmed instructions, and this signal-bearing medium may be downloaded through an interface (e.g., 350) to the data processing system 300 from the network by end users or potential buyers.

As mentioned, detail-in-context presentations of data using techniques such as pliable surfaces, as described by Carpendale, are useful in presenting large amounts of information on limited-size display surfaces. Detail-in-context views allow magnification of a particular region-of-interest (e.g., the focal region) 233 in a data presentation while preserving visibility of the surrounding information 210. In the following, a GUI 400 is described having lens control elements that can be implemented in software (and/or hardware) and applied to the control of detail-in-context data presentations. The software (and/or hardware) can be loaded into and run by the data processing system 300 of FIG. 3.

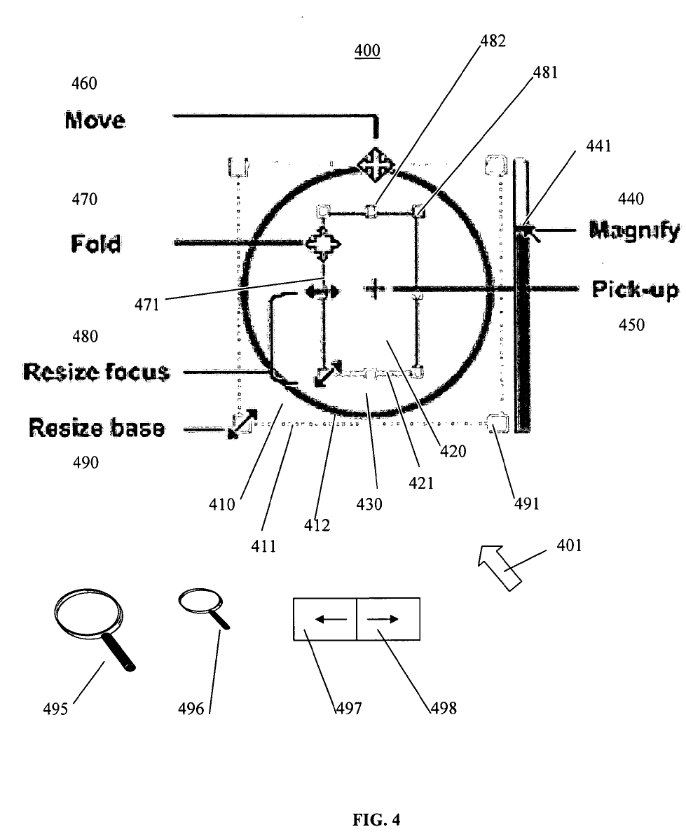

FIG. 4 is a partial screen capture illustrating a GUI 400 having lens control elements for user interaction with detail-in-context data presentations. Detail-in-context data presentations are characterized by magnification of areas of an image where detail is desired, in combination with compression of a restricted range of areas of the remaining information (i.e. the context), the end result typically giving the appearance of a lens having been applied to the display screen surface. This lens 410 includes a “focal region” 420 having high magnification, a surrounding “shoulder region” 430 where information is typically visibly compressed, and a “base” 412 surrounding the shoulder region 430 and defining the extent of the lens 410. In FIG. 4, the lens 410 is shown with a circular shaped base 412 (or outline) and with a focal region 420 lying near the center of the lens 410. However, the lens 410 and focal region 420 may have any desired shape. As mentioned above, the base of the lens 412 may be coextensive with the focal region 420.

In general, the GUI 400 has lens control elements that, in combination, provide for the interactive control of the lens 410. The effective control of the characteristics of the lens 410 by a user (i.e., dynamic interaction with a detail-in-context lens) is advantageous. At any given time, one or more of these lens control elements may be made visible to the user on the display surface 340 by appearing as overlay icons on the lens 410. Interaction with each element is performed via the motion of an input or pointing device 310 (e.g., a mouse) with the motion resulting in an appropriate change in the corresponding lens characteristic. As will be described, selection of which lens control element is actively controlled by the motion of the pointing device 310 at any given time is determined by the proximity of the icon representing the pointing device 310 (e.g., cursor) on the display surface 340 to the appropriate component of the lens 410. For example, “dragging” of the pointing device at the periphery of the bounding rectangle of the lens base 412 causes a corresponding change in the size of the lens 410 (i.e., “resizing”). Thus, the GUI 400 provides the user with a visual representation of which lens control element is being adjusted through the display of one or more corresponding icons.

For ease of understanding, the following discussion will be in the context of using a two-dimensional pointing device 310 that is a mouse, but it will be understood that the techniques may be practiced with other 2D or 3D (or even greater numbers of dimensions) input devices including a trackball, a keyboard, a position tracking device, an eye tracking device, an input from a navigation device, etc.

A mouse 310 controls the position of a cursor icon 401 that is displayed on the display screen 340. The cursor 401 is moved by moving the mouse 310 over a flat surface, such as the top of a desk, in the desired direction of movement of the cursor 401. Thus, the two-dimensional movement of the mouse 310 on the flat surface translates into a corresponding two-dimensional movement of the cursor 401 on the display screen 340.

A mouse 310 typically has one or more finger actuated control buttons (i.e., mouse buttons). While the mouse buttons can be used for different functions such as selecting a menu option pointed at by the cursor 401, a single mouse button may also be used to “select” a lens 410 and to trace the movement of the cursor 401 along a desired path. Specifically, to select a lens 410, the cursor 401 is first located within the extent of the lens 410. In other words, the cursor 401 is “pointed” at the lens 410. Next, the mouse button is depressed and released. That is, the mouse button is “clicked”. Selection is thus a point and click operation. To trace the movement of the cursor 401, the cursor 401 is located at the desired starting location, the mouse button is depressed to signal the computer 320 to activate a lens control element, and the mouse 310 is moved while maintaining the button depressed. After the desired path has been traced, the mouse button is released. This procedure is often referred to as “clicking” and “dragging” (i.e., a click and drag operation). It will be understood that a predetermined key on a keyboard 310 could also be used to activate a mouse click or drag. In the following, the term “clicking” will refer to the depression of a mouse button indicating a selection by the user and the term “dragging” will refer to the subsequent motion of the mouse 310 and cursor 401 without the release of the mouse button.

The GUI 400 may include the following lens control elements: move, pickup, resize base, resize focus, fold, magnify, zoom, and scoop. Each of these lens control elements has at least one lens control icon or alternate cursor icon associated with it. In general, when a lens 410 is selected by a user through a point and click operation, the following lens control icons may be displayed over the lens 410: pickup icon 450, base outline icon 412, base bounding rectangle icon 411, focal region bounding rectangle icon 421, handle icons 481, 482, 491 magnify slide bar icon 440, zoom icon 495, and scoop slide bar icon (not shown). Typically, these icons are displayed simultaneously after selection of the lens 410. In addition, when the cursor 401 is located within the extent of a selected lens 410, an alternate cursor icon 460, 470, 480, 490, 495 may be displayed over the lens 410 to replace the cursor 401 or may be displayed in combination with the cursor 401. These lens control elements, corresponding icons, and their effects on the characteristics of a lens 410 are described below with reference to FIG. 4.

In general, when a lens 410 is selected by a point and click operation, bounding rectangle icons 411, 421 are displayed surrounding the base 412 and focal region 420 of the selected lens 410 to indicate that the lens 410 has been selected. With respect to the bounding rectangles 411, 421 one might view them as glass windows enclosing the lens base 412 and focal region 420, respectively. The bounding rectangles 411, 421 include handle icons 481, 482, 491 allowing for direct manipulation of the enclosed base 412 and focal region 420 as will be explained below. Thus, the bounding rectangles 411, 421 not only inform the user that the lens 410 has been selected, but also provide the user with indications as to what manipulation operations might be possible for the selected lens 410 though use of the displayed handles 481, 482, 491. Note a bounding region may also have a shape other than generally rectangular. Such a bounding region could be of any of a great number of shapes including oblong, oval, ovoid, conical, cubic, cylindrical, polyhedral, spherical, etc.

Moreover, the cursor 401 provides a visual cue indicating the nature of an available lens control element. As such, the cursor 401 will generally change in form by simply pointing to a different lens control icon 450, 412, 411, 421, 481, 482, 491, 492, 440. For example, when resizing the base 412 of a lens 410 using a corner handle 491, the cursor 401 will change form to a resize icon 490 once it is pointed at (i.e., positioned over) the corner handle 491. The cursor 401 will remain in the form of the resize icon 490 until the cursor 401 has been moved away from the corner handle 491.

Lateral movement of a lens 410 is provided by the move lens control element of the GUI 400. This functionality is accomplished by the user first selecting the lens 410 through a point and click operation. Then, the user points to a point within the lens 410 that is other than a point lying on a lens control icon 450, 412, 411, 421, 481, 482, 491, 492, 440. When the cursor 401 is so located, a move icon 460 is displayed over the lens 410 to replace the cursor 401 or may be displayed in combination with the cursor 401. The move icon 460 not only informs the user that the lens 410 may be moved, but also provides the user with indications as to what movement operations are possible for the selected lens 410. For example, the move icon 460 may include arrowheads indicating up, down, left, and right motion. Next, the lens 410 is moved by a click and drag operation in which the user clicks and drags the lens 410 to the desired position on the screen 340 and then releases the mouse button 310. The lens 410 is locked in its new position until a further pickup and move operation is performed.

Lateral movement of a lens 410 is also provided by the pickup lens control element of the GUI. This functionality is accomplished by the user first selecting the lens 410 through a point and click operation. As mentioned above, when the lens 410 is selected a pickup icon 450 is displayed over the lens 410 near the centre of the lens 410. Typically, the pickup icon 450 will be a crosshairs. In addition, a base outline 412 is displayed over the lens 410 representing the base 412 of the lens 410. The crosshairs 450 and lens outline 412 not only inform the user that the lens has been selected, but also provides the user with an indication as to the pickup operation that is possible for the selected lens 410. Next, the user points at the crosshairs 450 with the cursor 401. Then, the lens outline 412 is moved by a click and drag operation in which the user clicks and drags the crosshairs 450 to the desired position on the screen 340 and then releases the mouse button 310. The full lens 410 is then moved to the new position and is locked there until a further pickup operation is performed. In contrast to the move operation described above, with the pickup operation, it is the outline 412 of the lens 410 that the user repositions rather than the full lens 410.

Resizing of the base 412 (or outline) of a lens 410 is provided by the resize base lens control element of the GUI. After the lens 410 is selected, a bounding rectangle icon 411 is displayed surrounding the base 412. For a rectangular shaped base 412, the bounding rectangle icon 411 may be coextensive with the perimeter of the base 412. The bounding rectangle 411 includes handles 491, 492. These handles 491, 492 can be used to stretch the base 412 taller or shorter, wider or narrower, or proportionally larger or smaller. The corner handles 491 will keep the proportions the same while changing the size. The middle handles (not shown) will make the base 412 taller or shorter, wider or narrower. Resizing the base 412 by the corner handles 491 will keep the base 412 in proportion. Resizing the base 412 by the middle handles will change the proportions of the base 412. That is, the middle handles change the aspect ratio of the base 412 (i.e., the ratio between the height and the width of the bounding rectangle 411 of the base 412). When a user points at a handle 491 with the cursor 401 a resize icon 490 may be displayed over the handle 491 to replace the cursor 401 or may be displayed in combination with the cursor 401. The resize icon 490 not only informs the user that the handle 491 may be selected, but also provides the user with indications as to the resizing operations that are possible with the selected handle. For example, the resize icon 490 for a corner handle 491 may include arrows indicating proportional resizing. The resize icon (not shown) for a middle handle may include arrows indicating width resizing or height resizing. After pointing at the desired handle 491 the user would click and drag the handle 491 until the desired shape and size for the base 412 is reached. Once the desired shape and size are reached, the user would release the mouse button 310. The base 412 of the lens 410 is then locked in its new size and shape until a further base resize operation is performed.

Resizing of the focal region 420 of a lens 410 is provided by the resize focus lens control element of the GUI. After the lens 410 is selected, a bounding rectangle icon 421 is displayed surrounding the focal region 420. For a rectangular shaped focal region 420, the bounding rectangle icon 421 may be coextensive with the perimeter of the focal region 420. The bounding rectangle 421 includes handles 481, 482. These handles 481, 482 can be used to stretch the focal region 420 taller or shorter, wider or narrower, or proportionally larger or smaller. The corner handles 481 will keep the proportions the same while changing the size. The middle handles 482 will make the focal region 420 taller or shorter, wider or narrower. Resizing the focal region 420 by the corner handles 481 will keep the focal region 420 in proportion. Resizing the focal region 420 by the middle handles 482 will change the proportions of the focal region 420. That is, the middle handles 482 change the aspect ratio of the focal region 420 (i.e., the ratio between the height and the width of the bounding rectangle 421 of the focal region 420). When a user points at a handle 481, 482 with the cursor 401 a resize icon 480 may be displayed over the handle 481, 482 to replace the cursor 401 or may be displayed in combination with the cursor 401. The resize icon 480 not only informs the user that a handle 481, 482 may be selected, but also provides the user with indications as to the resizing operations that are possible with the selected handle. For example, the resize icon 480 for a corner handle 481 may include arrows indicating proportional resizing. The resize icon 480 for a middle handle 482 may include arrows indicating width resizing or height resizing. After pointing at the desired handle 481, 482, the user would click and drag the handle 481, 482 until the desired shape and size for the focal region 420 is reached. Once the desired shape and size are reached, the user would release the mouse button 310. The focal region 420 is then locked in its new size and shape until a further focus resize operation is performed.

Folding of the focal region 420 of a lens 410 is provided by the fold control element of the GUI. In general, control of the degree and direction of folding (i.e., skewing of the viewer aligned vector 231 as described by Carpendale) is accomplished by a click and drag operation on a point 471, other than a handle 481, 482, on the bounding rectangle 421 surrounding the focal region 420. The direction of folding is determined by the direction in which the point 471 is dragged. The degree of folding is determined by the magnitude of the translation of the cursor 401 during the drag. In general, the direction and degree of folding corresponds to the relative displacement of the focus 420 with respect to the lens base 410. In other words, and referring to FIG. 2, the direction and degree of folding corresponds to the displacement of the point FP 233 relative to the point FPo 232, where the vector joining the points FPo 232 and FP 233 defines the viewer aligned vector 231. In particular, after the lens 410 is selected, a bounding rectangle icon 421 is displayed surrounding the focal region 420. The bounding rectangle 421 includes handles 481, 482. When a user points at a point 471, other than a handle 481, 482, on the bounding rectangle 421 surrounding the focal region 420 with the cursor 401, a fold icon 470 may be displayed over the point 471 to replace the cursor 401 or may be displayed in combination with the cursor 401. The fold icon 470 not only informs the user that a point 471 on the bounding rectangle 421 may be selected, but also provides the user with indications as to what fold operations are possible. For example, the fold icon 470 may include arrowheads indicating up, down, left, and right motion. By choosing a point 471, other than a handle 481, 482, on the bounding rectangle 421 a user may control the degree and direction of folding. To control the direction of folding, the user would click on the point 471 and drag in the desired direction of folding. To control the degree of folding, the user would drag to a greater or lesser degree in the desired direction of folding. Once the desired direction and degree of folding is reached, the user would release the mouse button 310. The lens 410 is then locked with the selected fold until a further fold operation is performed.

Magnification of the lens 410 is provided by the magnify lens control element of the GUI. After the lens 410 is selected, the magnify control is presented to the user as a slide bar icon 440 near or adjacent to the lens 410 and typically to one side of the lens 410. Sliding the bar 441 of the slide bar 440 results in a proportional change in the magnification of the lens 410. The slide bar 440 not only informs the user that magnification of the lens 410 may be selected, but also provides the user with an indication as to what level of magnification is possible. The slide bar 440 includes a bar 441 that may be slid up and down, or left and right, to adjust and indicate the level of magnification. To control the level of magnification, the user would click on the bar 441 of the slide bar 440 and drag in the direction of desired magnification level. Once the desired level of magnification is reached, the user would release the mouse button 310. The lens 410 is then locked with the selected magnification until a further magnification operation is performed. In general, the focal region 420 is an area of the lens 410 having constant magnification (i.e., if the focal region is a plane). Again referring to FIGS. 1 and 2, magnification of the focal region 420, 233 varies inversely with the distance from the focal region 420, 233 to the reference view plane (RVP) 201. Magnification of areas lying in the shoulder region 430 of the lens 410 also varies inversely with their distance from the RVP 201. Thus, magnification of areas lying in the shoulder region 430 will range from unity at the base 412 to the level of magnification of the focal region 420.

Zoom functionality is provided by the zoom lens control element of the GUI. Referring to FIG. 2, the zoom lens control element, for example, allows a user to quickly navigate to a region of interest 233 within a continuous view of a larger presentation 210 and then zoom in to that region of interest 233 for detailed viewing or editing. Referring to FIG. 4, the combined presentation area covered by the focal region 420 and shoulder region 430 and surrounded by the base 412 may be referred to as the “extent of the lens”. Similarly, the presentation area covered by the focal region 420 may be referred to as the “extent of the focal region”. The extent of the lens may be indicated to a user by a base bounding rectangle 411 when the lens 410 is selected. The extent of the lens may also be indicated by an arbitrarily shaped figure that bounds or is coincident with the perimeter of the base 412. Similarly, the extent of the focal region may be indicated by a second bounding rectangle 421 or arbitrarily shaped figure. The zoom lens control element allows a user to: (a) “zoom in” to the extent of the focal region such that the extent of the focal region fills the display screen 340 (i.e., “zoom to focal region extent”); (b) “zoom in” to the extent of the lens such that the extent of the lens fills the display screen 340 (i.e., “zoom to lens extent”); or, (c) “zoom in” to the area lying outside of the extent of the focal region such that the area without the focal region is magnified to the same level as the extent of the focal region (i.e., “zoom to scale”).

In particular, after the lens 410 is selected, a bounding rectangle icon 411 is displayed surrounding the base 412 and a bounding rectangle icon 421 is displayed surrounding the focal region 420. Zoom functionality is accomplished by the user first selecting the zoom icon 495 through a point and click operation When a user selects zoom functionality, a zoom cursor icon 496 may be displayed to replace the cursor 401 or may be displayed in combination with the cursor 401. The zoom cursor icon 496 provides the user with indications as to what zoom operations are possible. For example, the zoom cursor icon 496 may include a magnifying glass. By choosing a point within the extent of the focal region, within the extent of the lens, or without the extent of the lens, the user may control the zoom function. To zoom in to the extent of the focal region such that the extent of the focal region fills the display screen 340 (i.e., “zoom to focal region extent”), the user would point and click within the extent of the focal region. To zoom in to the extent of the lens such that the extent of the lens fills the display screen 340 (i.e., “zoom to lens extent”), the user would point and click within the extent of the lens. Or, to zoom in to the presentation area without the extent of the focal region, such that the area without the extent of the focal region is magnified to the same level as the extent of the focal region (i.e., “zoom to scale”), the user would point and click without the extent of the lens. After the point and click operation is complete, the presentation is locked with the selected zoom until a further zoom operation is performed.

Alternatively, rather than choosing a point within the extent of the focal region, within the extent of the lens, or without the extent of the lens to select the zoom function, a zoom function menu with multiple items (not shown) or multiple zoom function icons (not shown) may be used for zoom function selection. The zoom function menu may be presented as a pull-down menu. The zoom function icons may be presented in a toolbar or adjacent to the lens 410 when the lens is selected. Individual zoom function menu items or zoom function icons may be provided for each of the “zoom to focal region extent”, “zoom to lens extent”, and “zoom to scale” functions described above. In this alternative, after the lens 410 is selected, a bounding rectangle icon 411 may be displayed surrounding the base 412 and a bounding rectangle icon 421 may be displayed surrounding the focal region 420. Zoom functionality is accomplished by the user selecting a zoom function from the zoom function menu or via the zoom function icons using a point and click operation. In this way, a zoom function may be selected without considering the position of the cursor 401 within the lens 410.

The concavity or “scoop” of the shoulder region 430 of the lens 410 is provided by the scoop lens control element of the GUI. After the lens 410 is selected, the scoop control is presented to the user as a slide bar icon (not shown) near or adjacent to the lens 410 and typically below the lens 410. Sliding the bar (not shown) of the slide bar results in a proportional change in the concavity or scoop of the shoulder region 430 of the lens 410. The slide bar not only informs the user that the shape of the shoulder region 430 of the lens 410 may be selected, but also provides the user with an indication as to what degree of shaping is possible. The slide bar includes a bar that may be slid left and right, or up and down, to adjust and indicate the degree of scooping. To control the degree of scooping, the user would click on the bar of the slide bar and drag in the direction of desired scooping degree. Once the desired degree of scooping is reached, the user would release the mouse button 310. The lens 410 is then locked with the selected scoop until a further scooping operation is performed.

Advantageously, a user may choose to hide one or more lens control icons 450, 412, 411, 421, 481, 482, 491, 492, 440, 495 shown in FIG. 4 from view so as not to impede the user's view of the image within the lens 410. This may be helpful, for example, during an editing or move operation. A user may select this option through means such as a menu, toolbar, or lens property dialog box.

In addition, the GUI 400 maintains a record of control element operations such that the user may restore pre-operation presentations. This record of operations may be accessed by or presented to the user through “Undo” and “Redo” icons 497, 498, through a pull-down operation history menu (not shown), or through a toolbar.

Thus, detail-in-context data viewing techniques allow a user to view multiple levels of detail or resolution on one display 340. The appearance of the data display or presentation is that of one or more virtual lenses showing detail 233 within the context of a larger area view 210. Using multiple lenses in detail-in-context data presentations may be used to compare two regions-of-interest at the same time. Folding enhances this comparison by allowing the user to pull the regions-of-interest closer together. Moreover, using detail-in-context technology, a region-of-interest can be magnified to pixel level resolution, or to any level of detail available from the source information, for in-depth review. The digital images may include graphic images, maps, photographic images, or text documents, and the source information may be in raster, vector, or text form.

For example, in order to view a selected object or region-of-interest in detail, a user can define a lens 410 over the object or region-of-interest using the GUI 400. The lens 410 may be introduced to the original image to form a presentation through the use of a pull-down menu selection, tool bar icon, etc. Using lens control elements for the GUI 400, such as move, pickup, resize base, resize focus, fold, magnify, zoom, and scoop, as described above, the user adjusts the lens 410 for detailed viewing of the object or region-of-interest. Using the magnify lens control element, for example, the user may magnify the focal region 420 of the lens 410 to pixel quality resolution revealing detailed information pertaining to the selected object or region-of-interest. That is, a base image (i.e., the image outside the extent of the lens) is displayed at a low resolution while a lens image (i.e., the image within the extent of the lens) is displayed at a resolution based on a user selected magnification 440, 441.

In operation, the data processing system 300 employs EPS techniques with an input device 310 and GUI 400 for selecting objects or regions-of-interest for detailed display to a user on a display screen 340. Data representing an original image or representation is received by the CPU 320 of the data processing system 300. Using EPS techniques, the CPU 320 processes the data in accordance with instructions received from the user via an input device 310 and GUI 400 to produce a detail-in-context presentation. The presentation is presented to the user on a display screen 340. It will be understood that the CPU 320 may apply a transformation to the shoulder region 430 surrounding the focal region 420 to affect blending or folding in accordance with EPS techniques. For example, the transformation may map the focal region 420 and/or shoulder region 430 to a predefined lens surface 230, defined by a transformation or distortion function and having a variety of shapes, using EPS techniques. Or, the lens 410 may be simply coextensive with the region-of-interest or focal region 420.

The lens control elements of the GUI 400 are adjusted by the user via an input device 310 to control the characteristics of the lens 410 in the detail-in-context presentation. Using an input device 310 such as a mouse, a user adjusts parameters of the lens 410 using icons and scroll bars of the GUI 400 that are displayed over the lens 410 on the display screen 340. The user may also adjust parameters of the image of the full scene. Signals representing input device 310 movements and selections are transmitted to the CPU 320 of the data processing system 300 where they are translated into instructions for lens control.

Moreover, the lens 410 may be added to the presentation before or after the object or area is selected. That is, the user may first add a lens 410 to a presentation or the user may move a pre-existing lens into place over the selected object or region-of-interest. The lens 410 may be introduced to the original image to form the presentation through the use of a pull-down menu selection, tool bar icon, etc.

Advantageously, by using a detail-in-context lens 410 to select an object or region-of-interest for detailed information gathering, a user can view a large area (i.e., outside the extent of the lens 410) while focusing in on a smaller area (or within the focal region 420 of the lens 410) surrounding the selected object or region-of-interest. This makes it possible for a user to accurately gather detailed information without losing visibility or context of the portion of the original image surrounding the selected object or region-of-interest.

Thus, computer generated detail-in-context lens (or fisheye lens) presentations are a valuable tool for computer users. These presentations provide the ability to view data at multiple scales simultaneously, while preserving context, and maintaining continuity of data.

In order to render or generate such fisheye lens presentations, it is sometimes desirable or necessary to execute optimized or specialized rendering algorithms other than the displacement followed by perspective projection algorithm described above. These algorithms can be useful for overcoming limitations of hardware or software in any particular operating environment. As an example, United States Patent Application Publication No. 2003/0151625 by Shoemaker, which is incorporated herein by reference, discusses a rendering technique using pre-calculated texel coverages for the rendering of lenses. Also, United States Patent Application Publication No. 2003/0151626 by Komar et al., which is incorporated herein by reference, discusses the use of stretch bit-block transfer (“blit”) graphics operations for efficient rendering of pyramid shaped lenses.

While these two patent applications discuss rendering techniques that are useful for situations where performance needs to be optimized, there is another situation where a specialized rendering technique can be useful. This is the situation where not all standard graphics operations are available for a given data processing system. For example, if pixel copying operations are not available, then the technique described by U.S. Patent Application Publication No. 2003/0151625 would not be possible, and if stretch blit operations are not available, then the technique described in U.S. Patent Application Publication No. 2003/0151626 would not be possible.

In the following, a method is described for rendering pyramid shaped fisheye lenses using a minimum of graphics operations. Specifically, just image rendering, image scaling, depth ordering, and image masking capabilities are used in an embodiment. This method is advantageous in environments in which standard graphics operations are not all available. An example of such an environment is a Web browser. While it is possible to run full-featured executables, such as a Java™ Applet or ActiveX™ control (in which a full array of graphics capabilities are available) in a browser, sometimes it is desirable to implement all functionality using basic browser capabilities, such as hypertext markup language (“HTML”) rendering, using the document object model (“DOM”), and basic scripting, such as JavaScript™ Recently, this approach has become particularly popular and has been referred to as asynchronous JavaScript and XML (“AJAX”), where XML refers to the extensible markup language. While the method is not limited to this particular environment, this environment is one in which the method may be advantageously used.

At the root of the problem of rendering lenses in an AJAX client (e.g., Web browser) is the fact that rendering operations in such a client are limited. For example, JavaScript™ has almost no capability for rendering. It is used instead for manipulating elements in the DOM. The DOM does provide some capabilities for the visual presentation of data. Accordingly, the relevant client capabilities are as follows: images can be placed at a particular location in the browser window; images can be resized; rendering order can be changed; and, images can be masked (i.e., rectangular regions can be defined for each image where rendering occurs, outside of which no rendering takes place). The lens rendering or generating method herein differs from that of U.S. Patent Application Publication No. 2003/0151626 in that the graphics operations used are different. According to a method, for instance, one or more of image rendering, image resizing, image ordering, and image masking are used.

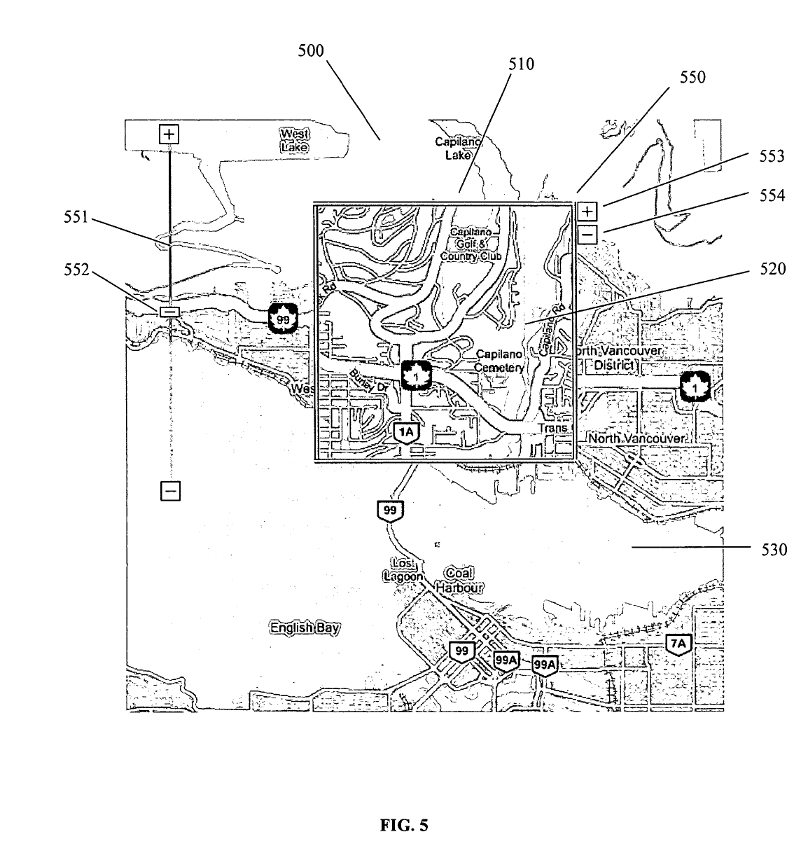

FIG. 5 is a screen capture illustrating a presentation 500 having a rectangular inset lens 510 in accordance with an embodiment. A rectangular inset lens 510 is a special case of a pyramid lens where the shoulder region is of zero size. An inset lens 510 applied to an original image magnifies a portion of that original image. The inset lens 510 is typically positioned over the location (i.e., the region-of-interest) in the original image that corresponds to the data or image 520 contained in the inset lens 510. The data or image 520 in the inset lens 510 may be derived from the same sources as the data for the original image, but in some circumstances the data may be derived from a different source. For example, a JPEG2000™ image may provide higher resolution data for an image 520 for the inset lens 510. Alternatively, an image server may provide higher resolution tiles that can be stitched into an image 520 for the inset lens 510.

In order to construct the presentation 500 of FIG. 5, first the original image is rendered. Next, the image(s) used to render the inset image 520 are obtained and are placed in the appropriate position relative to the original image. The inset image 520 may be comprised of one or more images. The images of the inset image 520 are layered in such a way that they are displayed over top of the original image. The presentation 500 thus has an inset image 520 and a surrounding contextual or context image 530, the contextual or context image 530 being that portion of the original image not covered by the inset image 520. The images for the inset image 520 may be scaled so that they appear at an appropriate scale on the display screen 340. Finally, since the images for the inset image 520 may cover more of the screen 340 than is necessary for the inset image 520, the images are masked such that they are only visible in the inset lens 510. This produces a presentation 500 having an inset lens 510 with an inset image 520 that shows a magnified or scaled version of a region-of-interest in the original image which is in turn surrounded (or at least partially surrounded) by context 530 from the original image.

In FIG. 5, an alternate GUI 550 is shown for adjusting the lens 510. The GUI 550 has a resize control element for adjusting the size of the inset image 520. The resize control element may have an associated slide bar icon 551 and bar icon 552 for manipulation by a user to resize the inset image 520. The GUI 500 also has a magnify control element for adjusting the magnification of the inset image 520. The magnify control element may have associated increase and decrease buttons 553, 554 for selection by a user to increase or decrease the magnification of the inset image 520 by discrete or continuous amounts.

A pyramid fisheye lens may be considered as a rectangular inset lens (e.g., 510) with an added shoulder region of variable magnification that joins the lens focal region (i.e., equivalent to the inset image 520 region of presentation 500 of FIG. 5) with the surrounding contextual region (i.e., equivalent to the contextual image 530 region of the presentation 500 of FIG. 5). The method for generating or rendering a pyramid fisheye lens is similar to that described above for an inset lens except that a number of renderings are performed at a scale or magnification that is in between the scale of the focal region and the scale of the contextual region (or original image) in order to approximate a smoothly varying lens shoulder region.

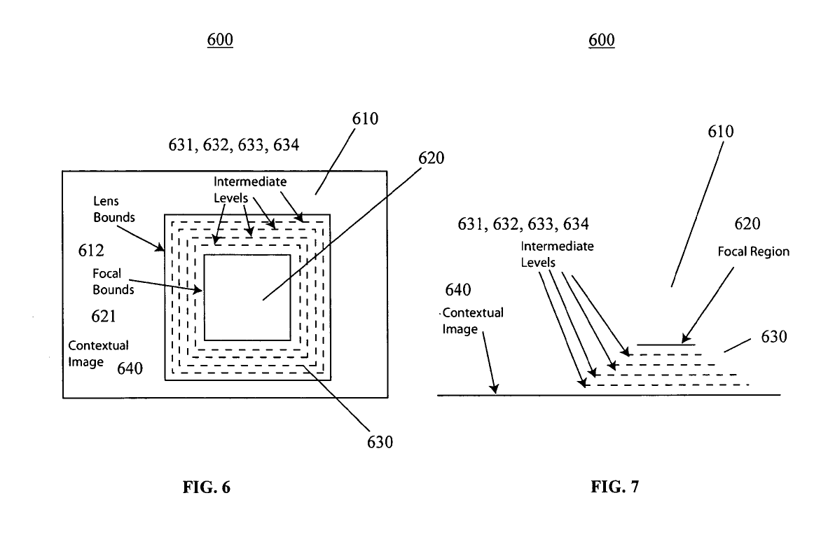

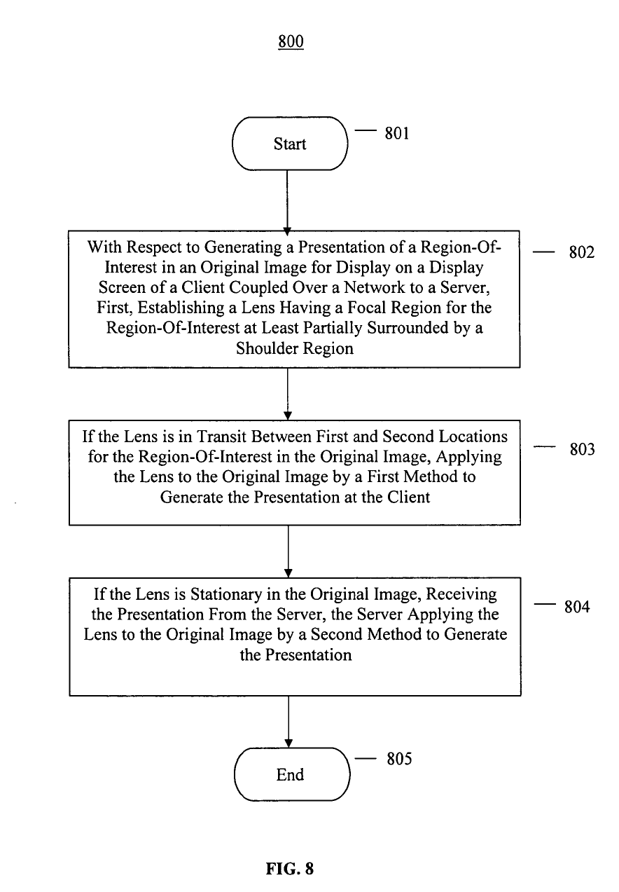

FIG. 6 is a top view illustrating the structure 600 of a pyramid lens 610 in accordance with an embodiment. And, FIG. 7 is a side view illustrating the pyramid lens 610 of FIG. 6 in accordance with an embodiment. The pyramid lens 610 includes a focal region 620 at least partially surrounded by a shoulder region 630. Separating the focal region 620 from the shoulder region 630 is a focal bounds 621. Separating the shoulder region 630 from the contextual region (i.e., the original image or the region of the original image to which the lens 610 is not applied) 640 is a lens bounds 612. The shoulder region 630 has one or more intermediate levels 631, 632, 633, 634 each having a corresponding intermediate level image (which will also be referred to as 631, 632, 633, 634 in the following, for convenience). The focal region 620 has a corresponding focal region image or inset image (which will also be referred to as 620 in the following, for convenience). And, the contextual region 640 has a corresponding contextual region image or original image (which will also be referred to as 640 in the following, for convenience).

The method uses a layering technique which stacks multiple renderings or images (i.e., intermediate level images 631, 632, 633, 634) on top of one another in order to render a pyramid lens 610. The method includes several steps (i.e., n steps). Step 1 consists of rendering the contextual image 640. Steps 2 to n−1 consist of rendering the intermediate level images 631, 632, 633, 634, where n is the number of intermediate levels (e.g., n=4 for FIGS. 6 and 7). Step n consists of rendering the inset image 620 as described above with respect to FIG. 5. Since step 1 is straight forward (the contextual image 640 being the original image or that portion of the original image that the pyramid lens 610 is not applied to) and step n is as described above, the following description will focus on steps 2 to n−1.

Steps 2 to n−1 are similar to the inset image rendering step n. What differs is that with each step from step 2 to step n−1, the region that is masked, in terms of screen coordinates, grows progressively smaller, and the data magnification level increases (and hence the data source may change, if different data sources are being used for different scales or magnification levels). The end result is that all intermediate level images 631, 632, 633, 634 are hidden except for a thin boundary around their respective perimeters or bounds. The effect is similar to a number of picture frames being stacked within one another, with each picture frame showing its picture (or data) at a different scale.

According to one embodiment, the change in region mask size can be varied in order to optimize for either quality or performance. If quality is to be optimized, then the mask can decrease in size to as little as 1 pixel per level 631, 632, 633, 634. This makes the approximation of the shoulder accurate to the level of 1 pixel, the best possible for a typical display screen 340. This will, however, result in possibly a large number of levels n being used, which may result in poor performance. The opposite strategy is to decrease the mask size in steps larger than 1 pixel per level 631, 632, 633, 634. Decreasing the number of steps lowers the quality of the rendering, but uses fewer levels n, hence improving performance.

Regardless of how the change in region masking size per level 631, 632, 633, 634 is chosen, the change in coverage of the level in data space, and hence the magnification of the underlying data, is to be chosen appropriately. In this case, “appropriately” means, first, that the levels 631, 632, 633, 634 vary such that at the lens boundary 612 where the shoulder region 630 meets the contextual image 640 and at the focal bounds 621 where the shoulder region 630 meets the focus image 620, the data (i.e., images 631, 634) in the shoulder region lines up with the adjoining data (i.e., images 640, 620) in the contextual and focal regions, and the magnification levels converge. The parameters defining the magnification and area of the levels 631, 632, 633, 634 may vary through the shoulder region 630. That is, the shoulder function or drop-off function (see above) defining the “shape” of the shoulder 630 may be arbitrary. However, according to one embodiment, the shape of the shoulder function (or distortion function defining the shape of the lens) is continuous providing a smooth transition from the contextual region 640 through the shoulder region 630 to the focal region 620.

According to one embodiment, the GUI 400 of FIG. 4 may be used to adjust the lens 610. For example, the scoop lens control element of the GUI 400 may be used to adjust the shape of the shoulder region 630 and hence the parameters defining the area of each level 631, 632, 633, 634. As another example, the magnification control element (i.e., slide bar and bar icons 440, 441) of the GUI 400 may be used to adjust the magnification of the focal region 620 and shoulder region 630 and hence the parameters defining the magnification of each level 631, 632, 633, 634.

According to another embodiment, the GUI 550 of FIG. 5 may be used to adjust the lens 610.

To reiterate, according to one embodiment, there is provided a method for generating a presentation of a region-of-interest in an original image 640 for display on a display screen 340, comprising: establishing a focal region for the region-of-interest at least partially surrounded by a shoulder region (e.g., selected by a user); creating a focal region image 620 for the focal region by scaling the original image within the focal region by a focal region magnification; creating a shoulder region image 631 for the shoulder region by scaling the original image within the shoulder region by a shoulder region magnification, the shoulder region magnification being less than the focal region magnification; and, overlaying the focal region image 620 and the shoulder region image 631 on the original image 640 to thereby generate the presentation.

In the above method, the step of creating the focal region image 620 may further include masking regions of the original image 640 outside the focal region, the step of creating the shoulder region image 631 may further include masking regions of the original image 640 outside the shoulder region, and the step of overlaying may further include masking regions of the original image 640 within the focal and shoulder regions. The shoulder region image 631 may comprise a sequence of shoulder region images 631, 632, 633, 634 to smoothly (e.g., continuously) join the focal region image 620 to the original image 640. Each of the sequence of shoulder region images 631, 632, 633, 634 may have a respective shoulder region magnification that increases from a shoulder region image 631 adjacent to the original image 640 to a shoulder region image 634 adjacent to the focal region image 620. Each of the sequence of shoulder regions images 631, 632, 633, 634 may have a respective size that decreases from a shoulder region image adjacent 631 to the original image 640 to a shoulder region image 634 adjacent to the focal region image 620. The method may further include receiving one or more signals to adjust the focal region through a graphical user interface (“GUI”) 400, 550 having means for adjusting at least one of a size of the focal region, a shape of the focal region, and the focal region magnification. The means for adjusting the size and shape may be at least one handle icon 481, 482 positioned on a perimeter 421, 621 of the focal region and the means for adjusting the focal region magnification may be at least one of a slide bar icon 440, 441, an increase magnification button 553, and a decrease magnification button 554. The shoulder region magnification may be a function of the focal region magnification. The method may further include receiving one or more signals to adjust the shoulder region through a graphical user interface (“GUI”) 440, 550 having means for adjusting at least one of a size of the shoulder region, a shape of the shoulder region, and a shape of the function (e.g., the scoop or shape of the distortion function, shoulder function, or shoulder drop-off function, etc.). The means for adjusting the size and shape may be at least one handle icon 491 positioned on a perimeter 411, 412, 612 of the shoulder region and the means for adjusting the shape of the function may be a slide bar icon. The method may further include receiving one or more signals to adjust at least one of the focal region, the shoulder region, and the original image outside the shoulder region through a graphical user interface (“GUI”) 400 having means for at least one of: increasing the focal region magnification such that the focal region fills the display screen 340; increasing the focal and shoulder region magnifications such that the focal and shoulder regions fill the display screen 340; and, applying the focal region magnification uniformly to the focal region, the shoulder region, and the original image outside the shoulder region. The means may be a respective selectable zoom icon for each of the focal region, the shoulder region, and the original image outside the shoulder region. And, the means may be a respective selectable zoom area in each of the focal region, the shoulder region, and the original image outside the shoulder region.

Thus, there are a number of methods for generating detail-in-context presentations including the following: displacement followed by perspective projection (as described above and in U.S. Pat. No. 6,768,497 to Baar, et al, which is incorporated herein by reference); using pre-calculated texel coverages (as described in United States Patent Application Publication No. 2003/0151625 by Shoemaker); using stretch bit-block transfer (“blit”) operations (as described in United States Patent Application Publication No. 2003/0151626 by Komar et al.); and, using layering (and scaling, masking, etc.) as described above.

However, challenges remain with respect to generating detail-in-context presentations on the Internet and in other client/server applications where limitations on network bandwidth and server capacity may exist. In addition, limitations may exist with respect to the software installation and execution capabilities of client software (e.g., browser software) installed on clients coupled to a server. For example, in the case of an Internet “portal” site which may have thousands of users, the load on the server with respect to its rendering capacity and the impact on network bandwidth from thousands of connected clients may present significant design challenges. In addition, browser capabilities may be severely limited by security rules and other constraints at the client. Furthermore, it is often desirable that clients have no software installed other than JavaScript™ when browsing a given website.

The layering method described above may be considered as a client-side method for generating detail-in-context lens presentations. The software for implementing the method may be client-side software. However, this layering method may be limited due to current browser JavaScript™ capabilities. For example, the lenses generated may be restricted to simple truncated pyramid shapes (or similar shapes) and the quality of rendering of the lens' shoulder region 630 may be restricted by the number of layers 631, 632, 633, 634 used to build the pyramid shape. As described above, improved visual quality of the shoulder region 630 may be achieved by increasing the number of layers in the shoulder region and decreasing the size of each layer.

According to one embodiment there is provided a method for generating detail-in-context lens presentations in client/server systems (e.g., in performance-constrained online environments). This method can be used in conjunction with the above-described layering method (and potentially with other client-side lens generation methods) to improve the quality of detail-in-context lens presentations and to support the generation of new lens shapes. The method minimizes the demands on servers to perform server-side rendering yet preserves some lens generation functionality at the client in the event that website traffic or network or server limitations make server-side lens generation unavailable.

Now, during periods when a user is actively moving a lens 610 (i.e., a presentation of the lens) across an original image 640 on the display screen 340, the user is less sensitive to the quality of rendering of the shoulder or shoulder region 630 of the lens 610. Hence, the rendering quality may be decreased for the shoulder region 630 during periods of lens movement. According to one embodiment, during periods of lens movement initiated by the user (or otherwise), the operations required to generate a presentation of the lens 610 are performed by the client using, for example, the layering method described above. According to this embodiment, when the user stops moving the lens 610 about the original image 640 (e.g., if the user selects a particular location for the lens 610 in the original image 640, if a predetermined period of time expires, etc.), rendering of a presentation of the lens 610 is performed by the server and the rendered presentation of the lens 610 is then downloaded to the client for display of the client's display screen 340. Advantageously, since the server typically does not have the rendering limitations of the client, this method allows higher quality lens shoulders to be rendered by the server (e.g., by the displacement followed by perspective projection method, by the pre-calculated texel coverages method, by the stretch bit-block transfer method, etc.).

According to one embodiment, the layering method may be performed by the client during periods when the server or network is heavily loaded or is otherwise performing slowly.

According to one embodiment, the server may be used to render lens shapes other than simple truncated pyramids. For example, lenses with rounded shoulders, etc., may be generated by the server. Furthermore, the server can provide additional server-side rendering of new information or blending of new information layers.

According to one embodiment, the rendering or occasional rendering of lenses by the server can also be used to temporarily present content such as advertising to the client browser for presentation to the user on the display screen 340.

According to one embodiment, the higher quality rendering (e.g., by the displacement followed by perspective projection method, by the pre-calculated texel coverages method, by the stretch bit-block transfer method, etc.) may be provided by a separate lens rendering server or proxy server or by a lens rendering module downloaded to the client.

Advantageously, the above embodiments address the problem of a server not being able to keep up with the rendering demands of a large number of client users. In this case, client-side lens generation is maintained and the user is provided with useful detail-in-context presentations, albeit presentations that may have lens images 620, 630 or at least shoulder images 630 that are rendered at a lower quality.

The above described method may be summarized with the aid of a flowchart. FIG. 8 is a flow chart illustrating operations 800 of modules 331 within the memory 330 of a data processing system 300 for generating a presentation of a region-of-interest in an original image 640 for display on a display screen 340, the data processing system 300 coupled over a network to a server, in accordance with an embodiment.

At step 801, the operations 800 start.

At step 802, a lens 610 having a focal region 620 for the region-of-interest at least partially surrounded by a shoulder region 630 is established (e.g., by user selection, etc).

At step 803, if the lens 610 is in transit between first and second locations for the region-of-interest in the original image 640, the lens 610 is applied to the original image 640 by a first method to generate the presentation.

At step 804, if the lens 610 is stationary in the original image 640, the presentation is received from the server, the server having applied the lens 610 to the original image 640 by a second method to generate the presentation.

At step 805, the operations 800 end.

In the above method, the first method may require less resources (e.g., processing power, rendering functionality, etc.) than the second method. The lens 610 may have a shape and the second method may more accurately reflect the shape of the lens in the presentation than the first method. The shoulder region 630 may have a shape and the second method may more accurately reflect the shape of the shoulder region in the presentation than the first method. The second method may include displacing the original image 640 onto the lens 610 to produce a displaced image and projecting the displaced image onto a plane 201 in a direction 231 aligned with a viewpoint 240 for the region-of-interest 233. The first method may include: creating a focal region image for the focal region 620 by scaling the original image 640 within the focal region 620 by a focal region magnification; creating a shoulder region image for the shoulder region 630 by scaling the original image 640 within the shoulder region 630 by a shoulder region magnification, the shoulder region magnification being less than the focal region magnification; and, overlaying the focal region image and the shoulder region image on the original image 640. The method may further include receiving a signal indicating the transit between the first and second locations from a graphical user interface (“GUI”) 400 displayed over the lens 610 on the display screen 340. The method may further include, if the lens 610 is stationary in the original image 640, sending a signal from the system 300 to the server requesting the presentation. The method may further include, if the lens 610 is stationary in the original image 640 and if the server is unavailable, applying the lens 610 to the original image 640 by the first method to generate the presentation within the system 300. And, the method may further include displaying the presentation on the display screen 340.

According to one embodiment, the above method may be implemented by the server rather than, or in addition to, the client.

While this discussion is primarily discussed as a method, a person of ordinary skill in the art will understand that the apparatus discussed above with reference to a data processing system 300, may be programmed to enable the practice of the method. Moreover, an article of manufacture for use with a data processing system 300, such as a pre-recorded storage device or other similar computer readable medium including program instructions recorded thereon, may direct the data processing system 300 to facilitate the practice of the method. It is understood that such apparatus and articles of manufacture also come within the scope.

In particular, the sequences of instructions which when executed cause the method described herein to be performed by the data processing system 300 can be contained in a data carrier product according to one embodiment. This data carrier product can be loaded into and run by the data processing system 300. In addition, the sequences of instructions which when executed cause the method described herein to be performed by the data processing system 300 can be contained in a computer software product according to one embodiment. This computer software product can be loaded into and run by the data processing system 300. Moreover, the sequences of instructions which when executed cause the method described herein to be performed by the data processing system 300 can be contained in an integrated circuit product (e.g., a hardware module or modules) which may include a coprocessor or memory according to one embodiment. This integrated circuit product can be installed in the data processing system 300.

The embodiments described above are intended to be exemplary only. Those skilled in the art will understand that various modifications of detail may be made to these embodiments, all of which come within the scope.

What is claimed is:

1. A method comprising:
establishing a lens having a focal region for a region-of-interest in an original image for display on a display screen of a client, the region-of-interest at least partially surrounded by a shoulder region;
if the lens is in transit between first and second locations for the region-of-interest in the original image, displaying the lens on the display screen of the client as having a first rendering quality; and
if the lens is stationary in the original image, displaying the lens on the display screen of the client as having a second rendering quality that is greater than the first rendering quality.

2. The method of claim 1 wherein:
the displaying of the lens on the display screen of the client as having the first rendering quality is performed using a first method;
the displaying of the lens on the display screen of the client as having the second rendering quality is performed using a second method; and
the first method uses less resources of the client than the second method.

3. The method of claim 2 wherein the lens has a shape and the second method more accurately reflects the shape of the lens in the presentation than does the first method.

4. The method of claim 2 wherein the shoulder region has a shape and the second method more accurately reflects the shape of the shoulder region than does the first method.

5. The method of claim 2 wherein the second method includes displacing the original image onto the lens to produce a displaced image and projecting the displaced image onto a plane in a direction aligned with a viewpoint for the region-of-interest.

6. The method of claim 2 wherein the first method includes:
creating a focal region image for the focal region by scaling the original image within the focal region by a focal region magnification;
creating a shoulder region image for the shoulder region by scaling the original image within the shoulder region by a shoulder region magnification, the shoulder region magnification being less than the focal region magnification; and
overlaying the focal region image and the shoulder region image on the original image.

7. The method of claim 1 and further comprising receiving a signal indicating the transit between the first and second locations from a graphical user interface (“GUI”) displayed over the lens on the display screen of the client.

8. The method of claim 1 and further comprising, if the lens is stationary in the original image, sending a signal from the client to a server via the network to request a presentation the includes the display of the lens in the second rendering quality.

9. The method of claim 1 and further comprising, if the lens is stationary in the original image and if the display of the lens is unavailable in the second resolution, displaying the lens in the first rendering quality.

10. The method of claim 1 wherein the lens and the original image are layered during transit.

11. A system comprising:
a display screen;
a processor; and
memory coupled to the display screen and the processor, the memory configured to maintain one or more modules that are executable by the processor to:
establish a lens having a focal region for a region-of-interest in an original image for display on the display screen, the region-of-interest at least partially surrounded by a shoulder region;
if the lens is in transit between first and second locations for the region-of-interest in the original image, display a presentation that has the lens applied to the original image by a first method; and
if the lens is stationary in the original image, display a presentation that has the lens applied to the original image by a second method that uses more resources of the processor than the first method.

12. The system of claim 11 wherein the lens applied to the original image by the first method has a lower resolution than the lens applied to the original image by the second method.

13. The system of claim 12 wherein the lens has a shape and the second method more accurately reflects the shape of the lens in the presentation than does the first method.

14. The system of claim 11 wherein the shoulder region has a shape and the second method more accurately reflects the shape of the shoulder region in the presentation than does the first method.

15. The system of claim 14 wherein the second method includes displacing the original image onto the lens to produce a displaced image and projecting the displaced image onto a plane in a direction aligned with a viewpoint for the region-of-interest.

16. The system of claim 14 wherein the first method includes:
creating a focal region image for the focal region by scaling the original image within the focal region by a focal region magnification;
creating a shoulder region image for the shoulder region by scaling the original image within the shoulder region by a shoulder region magnification, the shoulder region magnification being less than the focal region magnification; and
overlaying the focal region image and the shoulder region image on the original image.

17. The system of claim 11 wherein the one or more modules are further executable to receive a signal indicating the transit between the first and second locations from a graphical user interface (“GUI”) displayed over the lens on the display screen.

18. The system of claim 11 wherein the one or more modules are further executable to send a signal to a server to request the presentation if the lens is stationary in the original image.

19. The system of claim 11 wherein the one or more modules are further executable to applying the lens to the original image by the first method to generate the presentation if the lens is stationary in the original image and a server is unavailable to generate the presentation by the second method.

20. The system of claim 11 wherein the one or more modules are further executable to display the presentation on the display screen.
